(19) United States
(12) Patent Application Publication
(10) Pub. No.: US 2019/0177502 A1
(43) Pub. Date: Jun. 13, 2019

(54) PROCESS FOR MAKING EXPANDABLE POLYVINYL CHLORIDE PASTE CONTAINING TRIMELLITATE PLASTICIZERS

(71) Applicant: Manduka LLC, El Segundo, CA (US)

(72) Inventor: James M. Hurley, Atlanta, GA (US)

(21) Appl. No.: 15/956,501

(22) Filed: Apr. 18, 2018

Related U.S. Application Data
(60) Provisional application No. 62/486,813, filed on Apr. 18, 2017.
(60) Provisional application No. 62/640,342, filed on Mar. 8, 2018.

(51) Int. Cl. C08J 9/10; C08J 9/00; C08K 5/09; C08K 5/10

(52) U.S. Cl. CPC C08J 9/103; C08J 9/009; C08J 2327/06; C08K 5/10; C08J 2205/06; C08K 5/09

(57) ABSTRACT

The present disclosure relates to the processing of a flexible polyvinyl chloride foam having predetermined characteristics formed from a polyvinyl chloride emulsion including polyvinyl chloride resin and a plasticizer by controlling one or more of the following: a concentration of stabilizer in the final foam, a heating rate during processing, a maximum temperature during fusion, and/or a total residence time during heating. Predetermined characteristics of interest for a flexible PVC foam may include, for example, low yellowness, uniform density, high compression modulus and/or a uniform cell morphology.

### RELATED APPLICATIONS AND INCORPORATION BY REFERENCE

Reference is made to U.S. Provisional Application Ser. No. 62/486,813, (“Hurley”) filed on Apr. 18, 2017, and all documents cited therein or during its prosecution (“application cited documents”) and all documents cited or referenced in the application cited documents, and all documents cited or referenced herein (herein “cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention. More specifically, all referenced documents are incorporated by reference to the same extent as if each individual document was specifically and individually indicated to be incorporated by reference.

### FIELD OF THE INVENTION

Polyvinyl chloride (“PVC”) foams are widely used in many applications such as furniture, transportation, bedding, carpet underlay, packaging, textiles, toys, and sport applications such as yoga mats because of their light weight, excellent strength/weight ratio, superior insulating and energy absorbing properties. Flexible PVC foams are prepared by first dispersing a PVC emulsion and blending-grade resins in a suitable plasticizer, along with smaller amounts of stabilizers, colorants and chemical blowing agents. The resulting paste is then spread onto a textile scrim or other suitable carrier, and then typically heated to 180-200° C. for fusing and foaming of the plastisol.

In the past, ortho-phthalates were the plasticizers of choice given their good plasticizing efficiency, fast fusion rates, low viscosity and competitive price. However, exposure to phthalates has more recently been associated with an increased risk for adverse male fetal reproductive development and government regulators around the world are increasing their scrutiny and restrictions on the use of phthalates. Therefore, there is a need for identifying suitable alternatives to phthalates in consumer applications.

In addition, many phthalate alternatives are prone to migrate or exude from fused plastisols, especially when subjected to compressive stresses along with elevated temperatures or just elevated temperatures only. Plasticizer migration in flexible foamed sports surface products, such as, for example, PVC yoga mats, is of particular concern, because an oily plasticizer film can accumulate, creating an unpleasant, slippery surface on a sports surface product and thereby create a risk of slipping injury. Removing the accumulated film necessitates an intensive “breaking-in” or cleaning procedure by the customer. Thus, there exists a need in the marketplace for a PVC sports surface product material that reduces or eliminates the need for breaking-in or cleaning of the product by the manufacturer or customer.

The Provisional Application titled FOAMABLE PVC FORMULATIONS WITH TRIMELLITATE PLASTICIZERS, Ser. No. 62/486,813, (“Hurley”), teaches the use of trimellitate plasticizers for producing PVC foams with reduced plasticizer migration and exudation tendencies as compared to other non-phthalate plasticizers. Additional experimentation has yielded some novel benefits over Hurley. For example, while having good values for plasticizer migration, that is, reduced migration when compared to alternatives, the closed-cell morphology of the tris (2-ethylhexyl) trimellitate (“TOTM”) containing foams described in Hurley were found to be of lesser quality when compared to foams produced with either the lower molecular-weight plasticizer Di-2-Ethylhexyl Terephthalate or K-Flex P975 Dibenzoate blend plasticizer. Therefore, a continued need in the marketplace exists for a PVC sports surface product material that reduces or eliminates the need for breaking-in or cleaning of the product by the manufacturer or customer, while still exhibiting a superior, uniform closed-cell foam structure.

### BACKGROUND OF THE INVENTION

Flexible PVC foams are generally described by their cell nature, that is, whether the cells have a closed or open cell structure. Closed cells tend to give good resistance to compression, but if compression occurs they will recover slowly. Open cells, while offering very low resistance to compression, will recover quickly from compressive force. In an article by J. Stehr the author states, “In addition to the type of cell, i.e., whether open or closed type, the quality of the cell will also need consideration. Cells can range from exceedingly fine to very coarse and this is controlled by a number of factors. Of key importance are the gelation rate, the gas evolution rate of the blowing agents involved and also the surfactant present from the PVC resin manufacturing process.” (J. Stehr, “Chemical blowing agents in the rubber industry. Past-present-and future?” Gummi Fasern Kunstoffe 68, p. 812-819 (2015).)

Further, Stehr, while discussing a review of chemical blowing agent states the following: “the curing of the elastomer matrix is responsible for fixing the cells. If gas is generated too early, the bubbles can expand without restriction, run into one another and collapse. This results in non-uniform, coarse cell structures, sink marks, craters, poor dimensional stability and, in the case of foam rubber profile extrusion without counter-pressure, irregularities on the profile surface. If the blowing agent reacts later than the curing system, the bubbles in the increasingly cured matrix cannot expand sufficiently, if at which results in too high a density or bursting cell structure.”

Confirmation for these trends is further provided by Zoller et. al. who showed that for azodicarbonamide-blown foams produced via rotationally molding, the best quality foams were prepared with those phthalate ester plasticizers having the lowest molecular weight such as Diethyl phthalate (“DEP”), Diisobutyl Phthalate (“DIBP”), and Diisoheptyl phthalate (“DIHP”). (3A. Zoller and A. Marcilla, “Soft PVC Foams: Study of the Gelation, Fusion, and Foaming Process. I. Phthalate Ester Plasticizers,” J. Applied Poly. Sci. 121, p. 1495-1505 (2011).) On the other hand, foams produced with higher molecular weight plasticizers like Diisononyl phthalate (“DINP”) (molecular weight≈418.6 daltons) and Diisodecyl phthalate (“DIDP”) (molecular weight≈446.7 daltons) under identical conditions exhibited striking defects, large holes and consequently higher mean size and less homogeneous distribution.

A similar trend was also shown by Zoller et. al. for non-phthalate plasticizers: the best foams were achieved with the lower molecular weight plasticizers: alkylsulfonic phenyl ester (Mesamoll), Dioctyl terephthalate (“DOTP”), DINCH, Acetyl tributyl citrate and Dihexyl adipate. (3A. Zoller and A. Marcilla, “Soft PVC Foams: Study of the Gelation, Fusion, and Foaming Process. II. Adipate, Citrate and Other Types of Plasticizers,” J. Applied Poly. Sci. 122, p. 2981-2991 (2011).) On the other hand pentaerythritol esters of fatty acids (molecular weight≈604-750 daltons) and polymeric adipates (molecular weight≈3300-7000 daltons) were wholly inadequate for producing uniform foams.

In addition, an article by Verdu et. al. interpreted these results in terms of the slow rate of melt strength development through inter particle welding and chain diffusion among the resin particles: higher molecular-weight plasticizers have slow rates of diffusion and thus develop melt strength more slowly (for a given temperature) than low molecular weight plasticizers. In cases where the oven temperature lies below a characteristic ‘fusion temperature’ for the given plasticizer, films will have poor mechanical properties, regardless of cure times. (J. Verdu, A. Zoller and A. Marcilla., “Plastisol Gelation and Fusion Rheological Aspects,” J. Applied Poly. Sci. 129, p. 2840-2847 (2013).) On the other hand, mechanical strength is developed quickly, once the characteristic fusion temperature has been reached. (J. Koleske, Paint and Coating Testing Manual MNL17-2^{ND}: 15th Edition of the Gardner-Sward Handbook. P. 104, ASTM Int. (2012).) This analysis is in accord with results obtained earlier by S. W. Critchley et. al., who used a temperature gradient bar to determine the minimum gelation temperature necessary to attain film-forming strength as a function of the plasticizer type. (S. W. Critchley, A. Hill, and C. Paton: “Use of the Graded Gel Block in Evaluating PVC Plastisols,” Chapter 14 in Advances in Chemistry, Vol. 48: Plasticization and Plasticizer Processes, American Chemical Society (1965).) In the case of foams using high molecular weight and slower-fusing plasticizers, decomposition of the azodicarbonamide blowing agent likely occurs before the plastisol melt has achieved sufficient cohesive strength to contain the gas bubbles formed.

In practice, using a temperature gradient bar, the practical fusion temperature of the di-2-ethylhexyl phthalate (“DOP”) is found to be around 168° C. The phthalates DINP and DIDP, with higher molecular-weights, have fusion temperatures of about 177° C. and 188° C., respectively, while that of TOTM is approximately 192° C.

The presently described method provides a process for processing of a PVC formulation which includes trimellitate plasticizers as a phthalate replacement while maintaining an acceptable rate of migration.

### SUMMARY OF THE INVENTION

Accordingly, it is an object of the invention not to encompass within the invention any previously known product, process of making the product, or method of using the product such that Applicants reserve the right and hereby disclose a disclaimer of any previously known product, process, or method. It is further noted that the invention does not intend to encompass within the scope of the invention any product, process, or making of the product or method of using the product, which does not meet the written description and enablement requirements of the USPTO (35 U.S.C. § 112, first paragraph) or the EPO (Article 83 of the EPC), such that Applicants reserve the right and hereby disclose a disclaimer of any previously described product, process of making the product, or method of using the product. It may be advantageous in the practice of the invention to be in compliance with Art. 53(c) EPC and Rule 28(b) and (c) EPC. Nothing herein is to be construed as a promise.

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

These and other embodiments are disclosed or are obvious from and encompassed by the following Detailed Description.

A process for making a formulation for a flexible PVC foam using a plasticizer, in particular, tris (2-ethylhexyl) trimellitate, is described herein. An emulsion of PVC and a plasticizer may be combined with a blowing agent, a stabilizer, and/or a kicker to form a PVC formulation. In some instances, the blowing agent and/or kicker may be added to one or more master batches and then added to the PVC formulation. For example, an azodicarbonamide blowing agent and/or a zinc-oxide kicker may be added to the PVC formulation in the form of concentrated master batches. In some embodiments, a high-speed mixer may be used to form the plastisol. In some embodiments, high speed centrifugation may be used to remove air bubbles after mixing. Heat is then provided to the plastisol. For example, an electrically heated batch-type oven may be used to cure acid/or foam the plastisol.

In general, heat may be provided at a temperature in a range from about 15° C. to 25° C., above the fusion temperature of the plasticizer. For example, heat may^{,} be provided to the plastisol at a temperature in a range from about 15° C. to 25° C., above the fusion temperature of tris (2-ethylhexyl) trimellitate. Heat may be applied to the plastisol for a period of less than about 10 minutes. In some instances, it may be beneficial for the duration of the application of heat to be less than about five minutes.

A flexible PVC foam having predetermined characteristics may be formed from a plastisol by controlling a concentration of stabilizer in the final foam, a heating rate during processing, a maximum temperature during fusion, and/or a total residence time during heating. Predetermined characteristics of interest for a flexible PVC foam may include, for example, low yellowness, uniform density, high compression modulus and/or a uniform cell morphology.

### BRIEF DESCRIPTION OF THE DRAWINGS

The following detailed description, given by way of example, but not intended to limit the invention solely to the specific embodiments described, may best be understood in conjunction with the accompanying drawings.

FIG. 1 depicts the calculated profiles according to Poppe for an air oven temperature setting of 213° C.; and

FIG. 2 shows 14 reference color standards for ASTM D848.

### DETAILED DESCRIPTION OF THE INVENTION

In theory, the problem of creating an acceptable foam with a high molecular weight, and slower fusing plasticizer might be addressed by reducing the rate of azodicarbonamide decomposition (i.e., blowing), through eliminating any activators, or kickers, and raising the oven temperature. However, it is a challenge to implement such theory in practice because of the following reasons: First, many of the traditional PVC stabilizers, for example, zinc/cadmium and zinc/lead soaps, as well as tin stabilizers (e.g. butyl tin maleate) are increasingly under government and regulatory scrutiny due to health concerns. Replacements of traditional PVC stabilizers, such as zinc-based stabilizers, for example, zinc, calcium/zinc-, and barium/zinc-stabilizers act to various degrees as activators for azodicarbonamide, as well as, increase the process temperature and/or oven residence time. Zinc based stabilizers may include calcium/zinc-soaps and/or barium/zinc-soaps. Use of these soaps may cause thermal. stress on the plastisol resulting in an increase in foam yellowness. Thus, there is increasing demand for thermal stabilizers.

In an earlier report, Poppe., (A. C. Poppe, “Verfahrenstechische and energetische Gesichtspunkte bei der Auswahl von Phthalat-Weichmachern zur Herstellung von Beschichtungspasten,” Kunststoffe 72, p. 13-16 (1972) Translation: “Process engineering and energetic aspects in the selection of phthalate plasticizers for the production of coating pastes.”), discussed the benefits of increased processing temperature for the phthalate plasticizers DINP and DIDP compared to faster-fusing DOP, while Exelby et. al. recommended reducing the activation of the blowing agent when using slower fusing phthalates. (J. H. Exelby, R. R. Puri and D. M. Henshaw, Handbook of Vinyl Formulating, Chapter 20: Blowing agents, p. 536.) However, no comprehensive approach has yet been devised for improving the quality of foams made with high molecular weight, non-phthalate plasticizers, particularly trimellitates. In particular, TOTM is of special interest, because of its very high molecular weight (546.8 daltons) and low migration tendencies. A challenge of using TOTM is its high fusion temperature.

In an embodiment, a PVC foam made with TOTM plasticizer along with a azodicarbonamide chemical blowing agent is provided. The process to formulate such a foam includes providing a plastisol paste that includes PVC. For example, a mixer speed may have a value in range between 1000-3000 rpm. In particular, a mixer speed of 2000 rpm may be used. The plastisol is heated using an oven having a set temperature greater than 10° C., preferably greater than 15° C. to 25° C., above the fusion temperature of the TOTM plasticizer. In some instances, the following variables may be predetermined, in particular the total residence time for heating and/or use of mixed metal stabilizer in predetermined amounts, for example, mixed metal soaps. For example, in an embodiment, the total oven residence time, not considering cooling time, should be less than five (5) minutes and the amount mixed metal stabilizers, in particular barium/zinc and calcium/zinc, should be controlled such that the total concentration of zinc-soaps in the plastisol is in a range between 0.1-0.5% by weight.

The present invention discloses compositions containing a desirable range of zinc-containing additives, used together with specific heating profiles consisting of a heating rate, maximum fusion temperatures and a total residence time. The above processes allow for making TOTM-plasticized PVC foams, which exhibit low yellowness, uniform density, high compression modulus and a uniform cell morphology. The following materials are used as part of such process:

### 1. Stabilizers:

1.1. Zinc octoate, Plastistab 2275 (AM Stabilizers)

1.2. Barium/Zinc mixed metal stabilizer, 5:1 ratio (Plastistab 2483, AM Stabilizers)

1.3. Calcium/Zinc mixed metal stabilizer, 10:1 ratio (Plastistab 3013, AM Stabilizers)

1.4. Barium Ricinoleate (City Chemical LLC)

### 2. PVC:

2.1. Solvin 370 HD emulsion grade resin, K value=70 (Inovyn)

2.2. Solvin 367 NF micro-suspension grade resin, K value=67 (Inovyn)

### 3. Plasticizers:

3.1. Di-2-ethylhexyl terephthalate (Eastman 168)

3.2.TOTM (Plasthall Hallstar)

### 4. Kicker:

4.1. Zinc Oxide USP 10 (Zinc Oxide LLC)

### 5. Processing and Dispersing Aids:

5.1. BYK 4100 (Altana)

5.2. Disperplast 1150 (Altana)

### 6. Blowing Agent:

6.1. Azodicarbonamide (Celogen® AZ 130)

7. Masterbatches 7.1. Azodicarbonamide Masterbatch: 100 g Celogen AZ-130 was slowly added to a mixture of 98 g Eastman 168 and 2 g Disperplast 1150 under intensive Cowles blade mixing to produce a bright orange paste. Azodicarbonamide concentration=50%

Although the present invention and its advantages have been described in detail, it should be understood that various changes, substitutions and alterations can be made herein without departing from the spirit and scope of the invention as defined in the appended claims.

The present invention will be further illustrated in the following Examples which are given for illustration purposes only and are not intended to limit the invention in any way.

The formulations and relative quantities of the raw materials used in the examples of the present disclosure are set forth in Table 1 below.

TABLE 1
Compositions investigated.

| | Comp. A | B | C (claimed) | D (claimed) | E (claimed) | F |
|---|---|---|---|---|---|---|
| Solvin 370 HD | 70 | 70 | 70 | 70 | 70 | 70 |
| Solvin 367 NF | 30 | 30 | 30 | 30 | 30 | 30 |
| Plasthall | 100 | 100 | 100 | 100 | 100 | 100 |
| TOTM | | | | | | |
| Plas-Chek | 3 | 3 | 3 | 3 | 3 | 3 |
| 770 | | | | | | |
| Plastistab | | 3 | 1 | | | |
| 2275 | | | | | | |
| Plastistab | | | | 3 | | |
| 2483 | | | | | | |
| Plastistab | | | | | 3 | |
| 3013 | | | | | | |
| Ba-ricinoleate | | | | | | 3 |
| BYK P4100 | 1 | 1 | 1 | 1 | 1 | 1 |
| Azo | 3.2 | 3.2 | 3.2 | 3.2 | 3.2 | 3.2 |
| Masterbatch | | | | | | |
| Total parts | 207.2 | 210.2 | 208.2 | 210.2 | 210.2 | 210.2 |
| % azo | 0.77 | 0.76 | 0.77 | 0.76 | 0.76 | 0.76 |
| % Zn-soap | 0.0 | 1.45 | 0.48 | 0.24 | 0.13 | 0.0 |

Note:
quantities are listed in phr, based on a combined 100 parts resins.

Samples of various foamable PVC formulations were prepared to evaluate the characteristics of the foamable PVC formulations. A 200 g sample of each of the various example PVC formulations were prepared. The plastisol pastes were prepared using a high-speed lab mixer equipped with a 2.5 inch Cowles blade. At 2000 rpm mixer speed, a maximum tip speed of 2.5*π*2000/12=1308 feet/min is calculated. The azodicarbonamide blowing agent and the zinc-oxide kicker (when used) were added to the formulations in the form of concentrated master batches. The Hegman finesse-of-grind of all finished pastes was found to be 5 or lower (<38 microns). After mixing, air bubbles were removed through high-speed centrifugation. Then, 5 gram samples of the various example plastisols were weighed into small aluminum weighing dishes (2.5-inch diameter), and cured for various lengths of time in a Quincy model 10 electrically heated batch-type oven. Various oven settings were investigated as part of the process.

Oven Cure Profiles: The temperature settings on the oven were adjusted to simulate conditions in a continuous production oven. Specifically, Poppe showed that the temperature of a coating in a continuous oven can be approximated by an equation derived from Newton's law of heating:

$$\frac{Δ T}{{Δ T}_{0}} = {e}^{- ∝ \cdot t / cp \cdot g}$$

where ΔT is the temperature difference between the hot oven air and the paste layer, ΔT₀ is the initial temperature difference between the oven air and the paste layer when entering the gelling tunnel (oven), α is the heat transfer coefficient, Cₚ is the specific heat of the paste and g is the coating weight per m². Expanding this equation, the temperature Tₜ of the paste at time t (seconds) is calculated:

Tₜ=T₀−ΔT₀·exp(−α·t/cₚ·g)

For the relevant case of a thick (0.6 cm) foam yoga mat, the following parameters were used:
Initial coating weight g: 2.35 kg/m².
Specific heat of the plastisol Cₚ: 1800 W/(m²·K)
Heat transfer coefficient α (high efficiency oven): 58 W/(m²·K)
Initial paste temperature: ˜35° C.

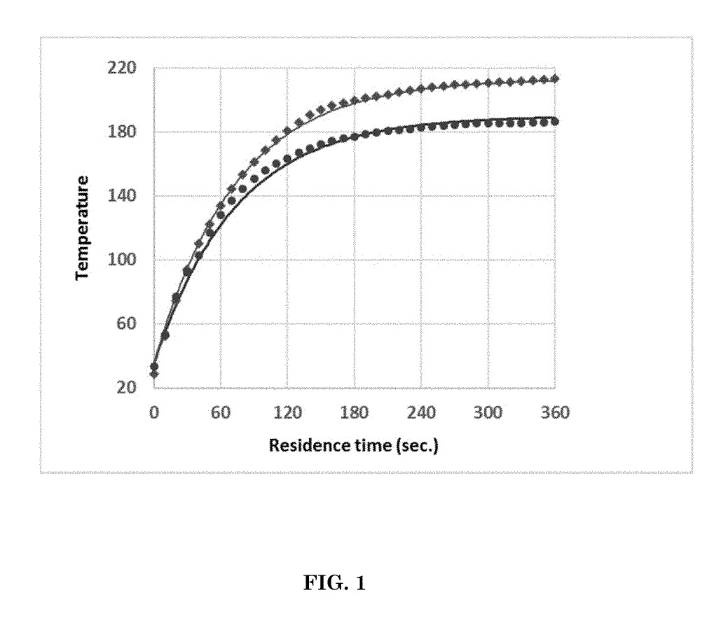

FIG. 1 shows the calculated profiles according to Poppe for an oven air temperature setting of 213° C.: high temperature condition (red line) and 190° C.: low temperature condition (blue line), are compared to actual temperature readings from the batch oven (red diamonds and blue dots, respectively) as measured with a thermocouple embedded in a plastisol sample. It is observed that a good agreement is obtained, i.e., the batch oven conditions used are compatible to a continuous manufacturing process.

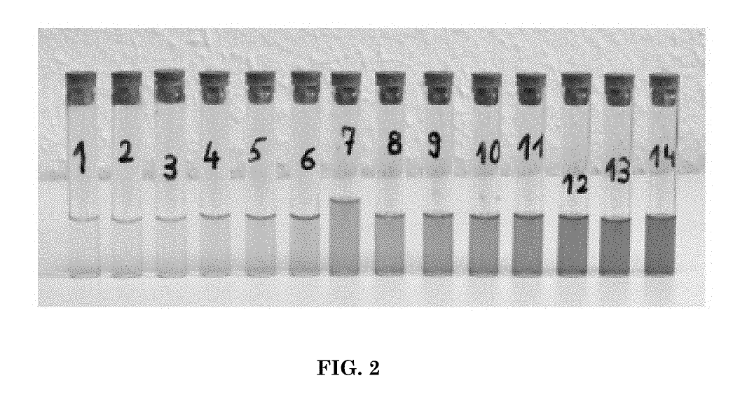

Further, samples of different composition were heated in the oven for various lengths of time using the high and low temperature conditions. After cooling, the samples were evaluated in terms of the foam density (ASTM D1622), Asker C durorneter hardness (JIS K 6301), Foam structure (optical microscopy and ASTM D3576) and yellowness (visually assessment versus liquid standards according to ASTM D848). The color numbers of the 14 reference color standards in ASTM D848 (Acid Wash Color of Industrial Aromatic Hydrocarbons) are depicted in FIG. 2.

The results are compiled in Table 2 shown below:

TABLE 2

| | | | Residence | Foam | Asker C | Foam Cell | Foam |
|---|---|---|---|---|---|---|---|
| Exp. | Composition | Oven setting | time | Density | Hardness | Structure | Color |
| 1 | A | H | 2 | 1.10 | 74 | NA | 6 |
| 2 | A | H | 3 | 0.87 | 64 | NA | 4 |
| 3 | A | H | 4 | 0.56 | 50 | + | 2 |
| 4 | A | H | 5 | 0.44 | 44 | + | 2 |
| 5 | A | H | 5.5 | 0.42 | 43 | +/− | 4 |
| 6 | B | H | 2 | 0.54 | 48 | ++ | 1 |
| 7 | B | H | 3 | 0.39 | 42 | ++ | 1 |
| 8 | B | H | 4 | 0.37 | 41 | +/− | 6 |
| 9 | B | H | 5 | 0.35 | 40 | −− | 11 |
| 10 | F | H | 3 | 0.87 | 64 | NA | 4 |
| 11 | F | H | 4 | 0.56 | 50 | +/− | 3 |
| 12 | F | H | 5 | 0.44 | 44 | +/− | 3 |
| 13 | F | H | 5.5 | 0.42 | 43 | − | 5 |
| 14 | C | H | 3 | 0.46 | 45 | ++ | 1 |
| 15 | C | H | 4 | 0.39 | 42 | ++ | 1 |
| 16 | C | H | 5 | 0.38 | 42 | +/− | 2 |
| 17 | D | H | 3 | 0.60 | 52 | ++ | 1 |
| 18 | D | H | 4 | 0.41 | 43 | ++ | 1 |
| 19 | D | H | 5 | 0.39 | 42 | ++ | 1 |
| 20 | E | H | 5 | 0.40 | 44 | + | 2 |
| 21 | B | L | 2 | 0.98 | 69 | NA | 4 |
| 22 | B | L | 0 | 0.50 | 47 | +/− | 1 |
| 23 | B | L | 4 | 0.40 | 43 | − | 4 |
| 24 | B | L | 5 | 0.39 | 42 | − | 11 |

In Table 2, under low temperature oven conditions with composition B (experiments #21-24), the majority of the azodicarbonamide reacts before the TOTM fusion temperature of approximately 192° C. has been reached. The foam has a poor morphology, exhibiting a non-uniform, coarse cell structures with sink marks and craters. In addition, even with a high concentration of the kicker stabilizer zinc-soap (˜1.5%), a residence time of 4-5 minutes is needed to achieve complete foaming. The long residence time, together with the high zinc-soap stabilizer content, leads to discoloration (a result of the so-called “zinc-sensitivity” of some PVC compositions).

On the other hand, under the high temperature oven condition, the TOTM fusion temperature is reached after about 160 seconds. In the case of the highly activated formula B (experiments #6-9), the majority of the azodicarbonamide has already reacted, (concomitant development of melt strength and foaming reaction). All foaming is essentially complete after 3 minutes and the end product is a high quality foam. However, this composition is sensitive to any additional oven residence time because the foams will quickly discolor with a coarsening of the cell structure (“over-blowing”). This high sensitivity and narrow process window makes it difficult to achieve a good quality uniform cell structure at the target density, without foam discoloration.

In addition, by using a zinc-free stabilizer such as barium-ricinoleate in composition F (experiments #10-13) or even in formulation A (no heat-stabilizer at all, experiments #1-5), the activity of the azodicarbonamide is greatly reduced, and complete foaming can be achieved in 5 minutes or more. And while the complete absence of zinc-soaps yields lighter colors even after a longer than preferred oven residence time, the foam structure formed is of lower quality than experiment #7 (i.e. where an activator is present and the residence time is short).

More satisfying results are obtained in the compositions C, E and especially D (experiments #14-16, 20, and 17-19, respectively) with a reduced concentration of zinc-soap as compared to composition B. An excellent foam structure is achieved after about 4 minutes of oven residence time, thereby allowing a wider process window for melt strength to develop. In addition, the zinc-sensitivity is drastically reduced resulting in lower foam yellowness and better color retention.

Having thus described in detail preferred embodiments of the present invention, it is to be understood that the invention defined by the above paragraphs is not to be limited to particular details set forth in the above description as many apparent variations thereof are possible without departing from the spirit or scope of the present invention.

What is claimed is:

1. A process for making a polyvinyl chloride foam, the process comprising:
providing a formulation further comprising:
a polyvinyl chloride resin;
a stabilizer;
a plasticizer; and
a chemical blowing agent;
providing heat to the formulation at temperature in a range from about 15° C. to 25° C. above a fusion temperature of the plasticizer;
wherein the heat is provided for a predetermined duration or less to form a plastisol; and wherein the stabilizer has a concentration in a range between 0.1-0.5% by weight in the plastisol.

2. A process for making a polyvinyl chloride foam, the process comprising:
providing a polyvinyl chloride formulation further comprising:
polyvinyl chloride resin; and
a tris (2-ethylhexyl) trimellitate plasticizer;
at least one zinc-based stabilizer; and
an azodicarbonamide chemical blowing agent;
providing heat to the polyvinyl chloride formulation at a temperature in a range between 15° C. to 25° C. above a fusion temperature of the tris (2-ethylhexyl) trimellitate plasticizer and for a total oven residence time of less than five minutes to form a plastisol; and
wherein a concentration of at least one mixed metal stabilizer in the polyvinyl chloride plastisol is in a range between 0.1-0.5% by weight.

3. The method of claim 1, wherein the plasticizer can comprise of at least one of a Di-2-ethylhexyl terephthalate (Eastman 168) or TOTM (Plasthall Hallstar).

4. The method of claim 1, wherein the stabilizer can comprise of at least one of a Zinc octoate, Plastistab 2275 (AM Stabilizers), Barium or Zinc mixed metal stabilizer (Plastistab 2483, AM Stabilizers), Calcium or Zinc mixed metal stabilizer (Plastistab 3013, AM Stabilizers) or Barium Ricinoleate (City Chemical LLC).

5. The method of claim 2, wherein the mixed metal stabilizer comprises at least one of a barium or zinc stabilizer.

6. The method of claim 2, wherein the mixed metal stabilizer comprises at least one of a calcium or zinc stabilizer.

7. The method of claim 2, wherein the temperature settings on the oven are configured to simulate conditions in a continuous production oven.

8. The method of claim 2, further configured to use high speed centrifugation to remove air bubbles from the plastisol.

9. A process for making a flexible foam, having predetermined characteristics forming a polyvinyl chloride emulsion including a polyvinyl chloride resin and a plasticizer, wherein the process is further configured to control:
a concentration of stabilizer in the final foam;
a heating rate during processing;
a maximum temperature during a fusion; and
a total residence time during the heating.

10. The method of claim 9, wherein the predetermined characteristics includes low yellowness, uniform density, high compression modulus and/or a uniform cell morphology.

11. A foamed sports article comprising the polyvinyl chloride foam composition of claim 1.

12. A foamed sports article comprising the polyvinyl chloride foam composition of claim 1 embedded over a textile substrate.
